(19) United States
(12) Patent Application Publication
(10) Pub. No.: US 2015/0117279 A1
(43) Pub. Date: Apr. 30, 2015

(54) DUAL BAND WIRELESS COMMUNICATION APPARATUS WITH ADVANCED HARMONIC REDUCTION CHARACTERISTICS

(71) Applicant: SAMSUNG ELECTRO-MECHANICS CO., LTD., Suwon-Si (KR)

(72) Inventor: Youn Suk KIM, Suwon-Si (KR)

(73) Assignee: SAMSUNG ELECTRO-MECHANICS CO., LTD., Suwon-Si (KR)

(21) Appl. No.: 14/259,996

(22) Filed: Apr. 23, 2014

(30) Foreign Application Priority Data
Oct. 31, 2013 (KR) 10-2013-0131164

(51) Int. Cl. H04W 88/06; H04B 1/00; H04W 84/12

(52) U.S. Cl. CPC H04W 88/06; H04W 84/12; H04B 1/0057
USPC 370/297; 455/552.1; 370/338

(57) ABSTRACT

A dual band wireless communications apparatus may include a first front-end unit configured to receive a power voltage and performing wireless communications processing using a first frequency band, a second front-end unit configured to receive the power voltage and performing wireless communications processing using a second frequency band higher than the first frequency band, and a harmonic filter unit connected between a power voltage terminal and a power terminal of the first front-end unit receiving the power voltage to block harmonics within a central frequency of the first frequency band.

### CROSS-REFERENCE TO RELATED APPLICATION

This application claims the benefit of Korean Patent Application No. 10-2013-0131164 filed on Oct. 31, 2013, with the Korean Intellectual Property Office, the disclosure of which is incorporated herein by reference.

### BACKGROUND

The present disclosure relates to a dual band wireless communications apparatus with advanced harmonic reduction characteristics.

A WiFi communications module used in a smartphone, a wireless Internet router, or the like may generally include two front-end modules to process a band of 2.4 GHz and a band of 5 GHz, respectively.

A wireless communications apparatus including the two front-end modules using frequency bands different from each other is referred to as a dual band wireless communications apparatus.

In such apparatuses, each of the front-end modules of the dual band wireless communications apparatus may include a radio frequency (RF) power amplifier to amplify a frequency band signal within the frequency band thereof.

In such a dual band wireless communications apparatus, it is advantageous to use power sources which are independent of each other as power sources of the two front-end modules, but power sources which are independent from each other may not be used due to lack of a mounting area, or the like and a single power source may be used.

According to an existing dual band wireless communications apparatus, a harmonic component within a low frequency band (e.g., 2.4 GHz) may adversely affect a high frequency band (e.g., 5 GHz), and particularly, in a case in which a single power source is used, such a harmonic component may directly affect such a high frequency band through a power line.

Existing dual band wireless communications apparatuses commonly use a bypass capacitor to prevent power source noise or interference between power sources.

However, a bypass capacitor may attenuate a harmonic component within a specific frequency to a certain degree, but it may be difficult to sufficiently attenuate a harmonic component within a low frequency band of a dual band.

For example, in a case in which a low frequency band of the dual band is 2.4 GHz and a high frequency band thereof is 5 GHz, since a secondary harmonic (2fo harmonic frequency) of a 2.4 GHz signal fo is 4.8 GHz, similar to a frequency (e.g., 5 GHz) of the high frequency band, the secondary harmonic within the low frequency band acts as an interference signal against the high frequency band to result in a performance deterioration. Therefore, a solution for performance deterioration is demanded.

The following Related Art Document, Patent Document 1, relates to a dual band front-end module but does not disclose technical contents of removing a secondary harmonic from within a low frequency band.

### RELATED ART DOCUMENT

(Patent Document 1) Korean Patent Laid-Open Publication No. 2005-0053829

### SUMMARY

An aspect of the present disclosure may provide a dual band wireless communications apparatus capable of improving harmonic reduction characteristics by removing a secondary harmonic from within a low frequency band of a dual band.

According to an aspect of the present disclosure, a dual band wireless communications apparatus may include: a first front-end unit configured to receive a power voltage and performing wireless communications processing using a first frequency band; a second front-end unit configured to receive the power voltage and performing wireless communications processing using a second frequency band higher than the first frequency band; and a harmonic filter unit connected between a power voltage terminal and a power terminal of the first front-end unit receiving the power voltage to block harmonics within a central frequency of the first frequency band.

According to another aspect of the present disclosure, a dual band wireless communications apparatus may include: a first front-end unit configured to receive a power voltage and performing wireless communications processing using a first frequency band; a second front-end unit configured to receive the power voltage and performing wireless communications processing using a second frequency band higher than the first frequency band; and a harmonic filter unit connected between a power voltage terminal and a power terminal of the second front-end unit receiving the power voltage to block harmonics within a central frequency of the first frequency band.

The harmonic filter unit may include at least one of a parallel resonance filter blocking secondary harmonics within the central frequency of the first frequency band and a series resonance filter allowing the secondary harmonics within the central frequency of the first frequency band to be bypassed to a ground.

According to another aspect of the present disclosure, a dual band wireless communications apparatus may include: a first front-end unit configured to receive a power voltage and performing wireless communications processing using a first frequency band; a second front-end unit configured to receive the power voltage and performing wireless communications processing using a second frequency band higher than the first frequency band; a diplexer disposed between each of the first front-end unit and the second front-end unit and an antenna terminal and allowing the first frequency band and the second frequency band to pass therethrough; a harmonic filter unit connected between a power voltage terminal and a power terminal of the first front-end unit receiving the power voltage to block harmonics within a central frequency of the first frequency band; and a band pass filter unit connected between the first front-end unit and the diplexer and allowing the first frequency band to pass therethrough.

The harmonic filter unit may include at least one of a parallel resonance filter blocking secondary harmonics within the central frequency of the first frequency band and a series resonance filter allowing the secondary harmonics within the central frequency of the first frequency band to be bypassed to a ground.

According to another aspect of the present disclosure, a dual band wireless communications apparatus may include: a first front-end unit configured to receive a power voltage and performing wireless communications processing using a first frequency band; a second front-end unit configured to receive the power voltage and performing wireless communications processing using a second frequency band higher than the first frequency band; a diplexer disposed between each of the first front-end unit and the second front-end unit and an antenna terminal and allowing the first frequency band and the second frequency band to pass therethrough; a first harmonic filter unit connected between a power voltage terminal and a power terminal of the first front-end unit receiving the power voltage to block harmonics within a central frequency of the first frequency band; a second harmonic filter unit connected between the power voltage terminal and a power terminal of the second front-end unit receiving the power voltage to block the harmonics within the central frequency of the first frequency band; and a band pass filter unit connected between the first front-end unit and the diplexer and allowing the first frequency band to pass therethrough.

Each of the first and second harmonic filter units may include at least one of a parallel resonance filter blocking secondary harmonics within the central frequency of the first frequency band and a series resonance filter allowing the secondary harmonics within the central frequency of the first frequency band to be bypassed to a ground.

The band pass filter unit may include at least one of a high pass filter allowing the central frequency of the first frequency band to pass therethrough and a low pass filter allowing the central frequency of the first frequency band to pass therethrough.

The first frequency band may be a wireless local area network (WLAN) frequency band of 2.4 GHz and the second frequency band may be a WLAN frequency band of 5 GHz.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram of a dual band wireless communications apparatus according to a first exemplary embodiment of the present disclosure;

FIG. 2 is a block diagram of a dual band wireless communications apparatus according to a second exemplary embodiment of the present disclosure;

FIG. 3 is a block diagram of a dual band wireless communications apparatus according to a third exemplary embodiment of the present disclosure;

FIG. 4 is a first implementation circuit diagram of a harmonic filter unit according to an exemplary embodiment of the present disclosure;

FIG. 5 is a second implementation circuit diagram of the harmonic filter unit according to an exemplary embodiment of the present disclosure;

FIG. 6 is a third implementation circuit diagram of the harmonic filter unit according to an exemplary embodiment of the present disclosure;

FIG. 7 is a graph diagram illustrating harmonic reduction characteristics of the dual band wireless communications apparatus according to an exemplary embodiment of the present disclosure;

FIG. 8 is a first implementation circuit diagram of a band pass filter according to an exemplary embodiment of the present disclosure; and

FIG. 9 is a second implementation circuit diagram of the band pass filter according to an exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

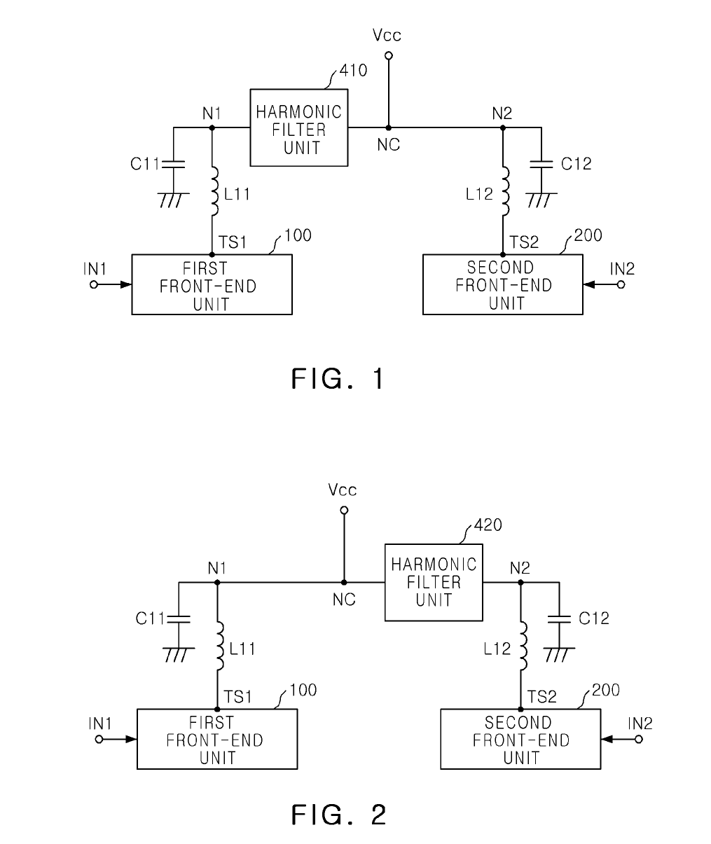

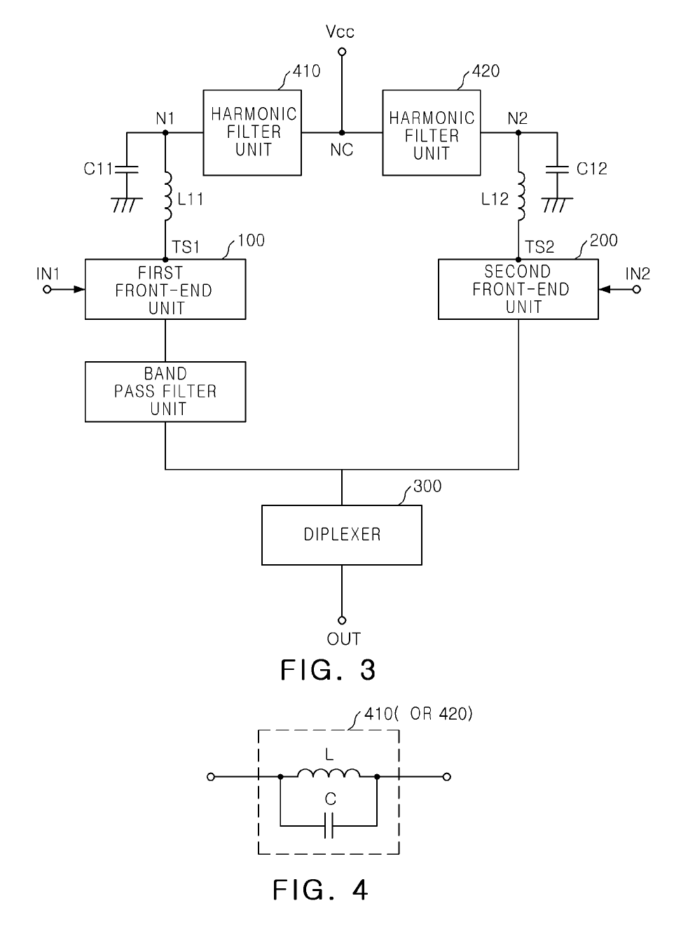

FIG. 1 is a block diagram of a dual band wireless communications apparatus according to a first exemplary embodiment of the present disclosure, FIG. 2 is a block diagram of a dual band wireless communications apparatus according to a second exemplary embodiment of the present disclosure, and FIG. 3 is a block diagram of a dual band wireless communications apparatus according to a third exemplary embodiment of the present disclosure.

Referring to FIGS. 1 through 3, each of the dual band wireless communications apparatuses according to the first, second, and third exemplary embodiments of the present disclosure may include a first front-end unit 100 and a second front-end unit 200.

The first front-end unit 100 may receive a power voltage Vcc supplied thereto through a chock inductor L11 and a capacitor C11 and may perform wireless communications processing on a signal that is input through an input terminal IN1 using a first frequency band.

The second front-end unit 200 may receive the power voltage Vcc supplied thereto through a chock inductor L12 and a capacitor C12 and may perform wireless communications processing on a signal that is input through an input terminal IN2 using a second frequency band higher than the first frequency band.

Here, the chock inductors L11 and L12 may block an alternating current component included in the power voltage Vcc, and the capacitors C11 and C12 may allow the alternating current component included in the power voltage Vcc to be bypassed to a ground.

In this case, each of the first front-end unit 100 and the second front-end unit 200 may be manufactured in a module type and the dual band wireless communications apparatus according to an exemplary embodiment of the present disclosure may also be manufactured in a module type including the first front-end unit 100 and the second front-end unit 200.

For example, the first frequency band may be a wireless local area network (WLAN) frequency band of 2.4 GHz and the second frequency band may be a WLAN frequency band of 5 GHz.

In this case, the first front-end unit 100 may perform wireless communications processing using the frequency band of 2.4 GHz and the second front-end unit 200 may process wireless communications using the frequency band of 5 GHz.

Referring to FIG. 1, the dual band wireless communications apparatus according to the first exemplary embodiment of the present disclosure may further include a harmonic filter unit 410.

The harmonic filter unit 410 may be connected between a terminal of the power voltage Vcc (hereinafter, referred to as a power voltage Vcc terminal) and a power terminal TS1 of the first front-end unit 100 that receives the power voltage Vcc and may block harmonics within a central frequency of the first frequency band.

As an implementation example, in a case in which the dual band wireless communications apparatus according to an exemplary embodiment of the present disclosure includes the chock inductor L11 and the capacitor C11, the harmonic filter unit 410 maybe connected between a connection node N1 provided between the chock inductor L11 and the capacitor C11 and a common connection node NC from which the power voltage Vcc is branched into the first and second front-end units 100 and 200, respectively.

For example, the first frequency band may be a wireless local area network (WLAN) frequency band of 2.4 GHz and the second frequency band may be a WLAN frequency band of 5 GHz.

In this case, the first harmonic filter unit 410 may block harmonics within the central frequency of the 2.4 GHz frequency band between a power voltage Vcc terminal and the first front-end unit 100.

Referring to FIG. 2, the dual band wireless communications apparatus according to the second exemplary embodiment of the present disclosure may further include a harmonic filter unit 420.

The harmonic filter unit 420 may be connected between the power voltage Vcc terminal and a power terminal TS2 of the second front-end unit 200 that receives the power voltage Vcc and may block harmonics within a central frequency of the first frequency band.

As an implementation example, in a case in which the dual band wireless communications apparatus according to an exemplary embodiment of the present disclosure includes the chock inductor L12 and the capacitor C12, the harmonic filter unit 420 maybe connected between a connection node N2 provided between the chock inductor L12 and the capacitor C12 and the common connection node NC from which the power voltage Vcc is branched into the first and second front-end units 100 and 200, respectively.

For example, the first frequency band may be a wireless local area network (WLAN) frequency band of 2.4 GHz and the second frequency band may be a WLAN frequency band of 5 GHz.

In this case, the harmonic filter unit 420 may block harmonics within the central frequency of the 2.4 GHz frequency band between the power voltage Vcc terminal and the second front-end unit 200.

Referring to FIG. 3, the dual band wireless communications apparatus according to the third exemplary embodiment of the present disclosure may further include the first and second harmonic filter units 410 and 420.

The first harmonic filter unit 410 may be connected between the power voltage Vcc terminal and the power terminal TS1 of the first front-end unit 100 that receives the power voltage Vcc and may block harmonics within the central frequency of the first frequency band.

As an implementation example, in a case in which the dual band wireless communications apparatus according to an exemplary embodiment of the present disclosure includes the chock inductor L11 and the capacitor C11, the first harmonic filter unit 410 may be connected between the connection node N1 provided between the chock inductor L11 and the capacitor C11 and the common connection node NC from which the power voltage Vcc is branched into the first and second front-end units 100 and 200, respectively.

For example, the first frequency band may be a wireless local area network (WLAN) frequency band of 2.4 GHz and the second frequency band may be a WLAN frequency band of 5 GHz.

In this case, the first harmonic filter unit 410 may block the harmonics within the central frequency of the 2.4 GHz frequency band between the power voltage Vcc terminal and the first front-end unit 100.

In addition, the second harmonic filter unit 420 may be connected between the power voltage Vcc terminal and the power terminal TS2 of the second front-end unit 200 that receives the power voltage Vcc and may block harmonics within the central frequency of the first frequency band.

As an implementation example, in a case in which the dual band wireless communications apparatus according to an exemplary embodiment of the present disclosure includes the chock inductor L12 and the capacitor C12, the second harmonic filter unit 420 may be connected between a connection node N2 with the chock inductor L12 and the capacitor C12 and a common connection node NC at which the power voltage Vcc is branched into the first and second front-end units 100 and 200, respectively.

For example, the first frequency band may be a wireless local area network (WLAN) frequency band of 2.4 GHz and the second frequency band may be a WLAN frequency band of 5 GHz.

In this case, the harmonic filter unit 420 may block the harmonics within the central frequency of the 2.4 GHz frequency band between the power voltage Vcc terminal and the second front-end unit 200.

In addition, referring to FIG. 3, the dual band wireless communications apparatus according to the third exemplary embodiment of the present disclosure may further include a diplexer 300 and a band pass filter unit 430.

The band pass filter unit 430 may be connected between the first front-end unit 200 and the diplexer 300 to allow the first frequency band to pass therethrough.

For example, the first frequency band may be a wireless local area network (WLAN) frequency band of 2.4 GHz and the second frequency band may be a WLAN frequency band of 5 GHz.

In this case, the band pass filter unit 430 may be connected between the first front-end unit 200 and the diplexer 300 to pass the 2.4 GHz frequency band and to block the frequency other than the 2.4 GHz frequency band.

In addition, the diplexer 300 may be disposed between each of the first front-end unit and the second front-end unit and an antenna terminal and allow the first frequency band and the second frequency band to pass therethrough.

That is, the diplexer 300 may be disposed between the first front-end unit 100 and an antenna terminal OUT to thereby allow the first frequency band to pass therethrough and may be disposed between the second front-end unit 200 and the antenna terminal OUT to thereby allow the second frequency band to pass therethrough.

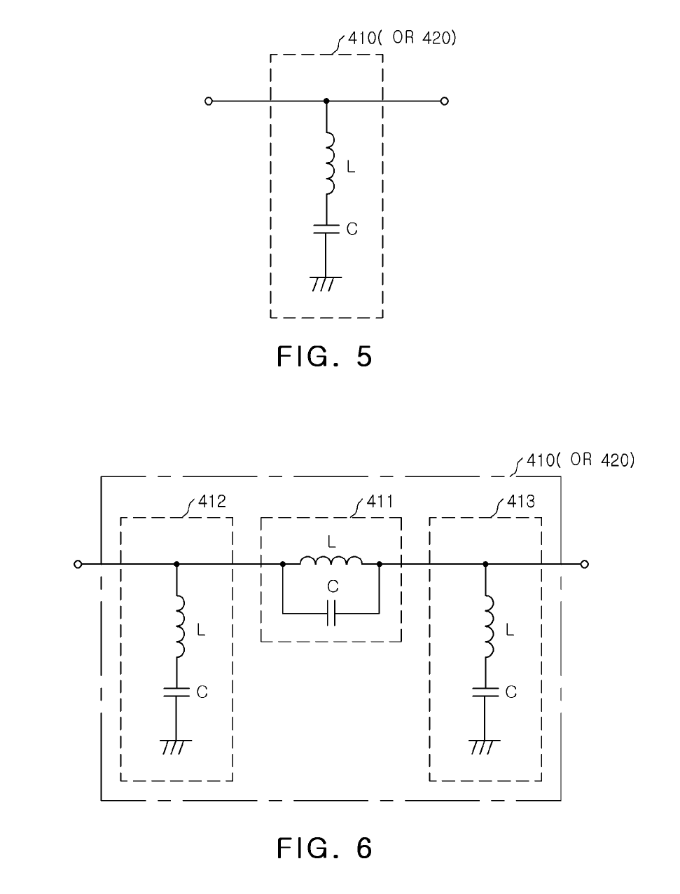

FIG. 4 is a first implementation circuit diagram of a harmonic filter unit according to an exemplary embodiment of the present disclosure. FIG. 5 is a second implementation circuit diagram of the harmonic filter unit according to an exemplary embodiment of the present disclosure. FIG. 6 is a third implementation circuit diagram of the harmonic filter unit according to an exemplary embodiment of the present disclosure.

Referring to FIG. 4, each of the first and second harmonic filter units 410 and 420 may include a parallel resonance filter blocking secondary harmonics (2fo) within a central frequency fo of the first frequency band.

Referring to FIG. 5, each of the first and second harmonic filter units 410 and 420 may include a series resonance filter allowing the secondary harmonics (2fo) within the central frequency fo of the first frequency band to be bypassed to a ground.

Referring to FIG. 6, each of the first and second harmonic filter units 410 and 420 may include a parallel resonance filter 411 blocking the secondary harmonics (2fo) within the central frequency fo of the first frequency band and series resonance filters 412 and 413 allowing the secondary harmonics (2fo) within the central frequency fo of the first frequency band to be bypassed to a ground.

For example, the first frequency band may be a wireless local area network (WLAN) frequency band of 2.4 GHz and the second frequency band may be a WLAN frequency band of 5 GHz.

In this case, the parallel resonance circuit 411 may block the secondary harmonics 2fo within the central frequency fo of the 2.4 GHz frequency band and the series resonance filters 412 and 413 may allow the secondary harmonics 2fo within the central frequency fo of the 2.4 GHz frequency band to be bypassed to the ground.

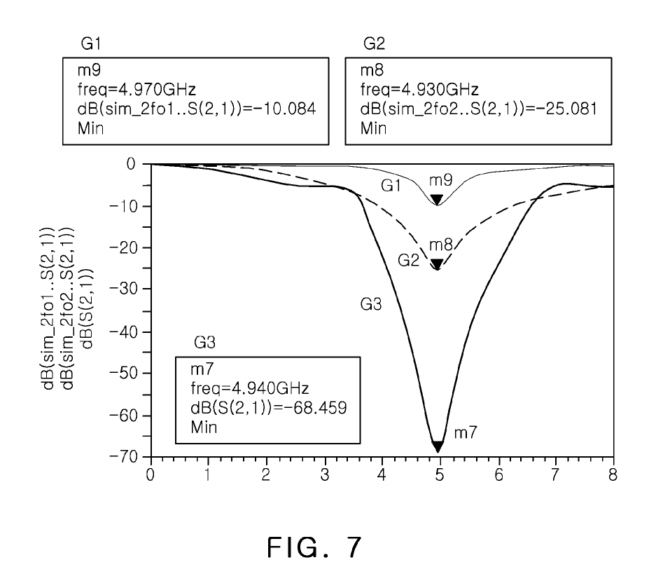

FIG. 7 is a graph diagram illustrating harmonic reduction characteristics of the dual band wireless communications apparatus according to an exemplary embodiment of the present disclosure.

The graph diagram of FIG. 7 illustrates frequency characteristics in a case in which the first frequency band is the WLAN frequency band of 2.4 GHz and the second frequency band is the WLAN frequency band of 5 GHz. In the graph diagram, a vertical axis indicates an insertion loss level [dB] and a horizontal axis indicates a frequency.

In FIG. 7, G1 indicates a graph showing harmonic reduction characteristics of the dual band wireless communications apparatus according to an exemplary embodiment of the present disclosure in a case in which the first harmonic filter unit 410 is implemented in the apparatus as shown in FIG. 4. G2 indicates a graph showing harmonic reduction characteristics of the dual band wireless communications apparatus according to an exemplary embodiment of the present disclosure in a case in which the first harmonic filter unit 410 is implemented in the apparatus as shown in FIG. 5. G3 indicates a graph showing harmonic reduction characteristics of the dual band wireless communications apparatus according to an exemplary embodiment of the present disclosure in a case in which the first harmonic filter unit 410 is implemented in the apparatus as shown in FIG. 6.

Referring to G1, G2, and G3, in the respective implementation examples of FIGS. 4 through 6, the harmonic reduction characteristics could be confirmed in the vicinity of a 4.8 GHz frequency in a secondary harmonic band of the 2.4 GHz frequency band, that is, G1(m9: 4.97 GHz), G2(m8: 4.93 GHz), and G3(m7: 4.94 GHz).

It may be appreciated that the implementation example of FIG. 6 exhibited the most excellent harmonic reduction characteristics, among the implementation examples of FIGS. 4 through 6.

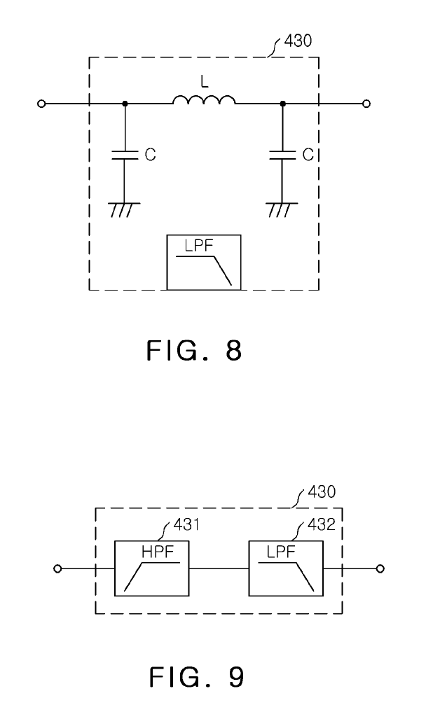

FIG. 8 is a first implementation circuit diagram of a band pass filter according to an exemplary embodiment of the present disclosure, and FIG. 9 is a second implementation circuit diagram of the band pass filter according to an exemplary embodiment of the present disclosure.

Referring to FIG. 8, the band pass filter 430 may include a low pass filter LPF allowing the central frequency fo of the first frequency band to pass therethrough.

For example, in a case in which the first frequency band is the WLAN frequency band of 2.4 GHz and the second frequency band is the WLAN frequency band of 5 GHz, the band pass filter 430 may allow the central frequency fo of the 2.4 GHz frequency band to low-pass therethrough and may block a high frequency band other than the 2.4 GHz frequency band.

Referring to FIG. 9, the band pass filter 430 may include the low pass filter LPF allowing the central frequency fo of the 2.4 GHz frequency band to pass therethrough and a high pass filter HPF allowing the central frequency fo of the 2.4 GHz frequency band to pass therethrough.

For example, in a case in which the first frequency band is the WLAN frequency band of 2.4 GHz and the second frequency band is the WLAN frequency band of 5 GHz, the band pass filter 430 may allow the central frequency fo of the 2.4 GHz frequency band and may block a frequency band other than the 2.4 GHz frequency band.

As set forth above, according to exemplary embodiments of the present disclosure, in order to prevent harmonic interference through a power source line when a single power source is supplied to a dual front-end, secondary harmonics in a low frequency band of a dual band may be removed, whereby harmonic reduction characteristic may be improved.

While exemplary embodiments have been shown and described above, it will be apparent to those skilled in the art that modifications and variations could be made without departing from the spirit and scope of the present disclosure as defined by the appended claims.

What is claimed is:

1. A dual band wireless communications apparatus, comprising:
a first front-end unit configured to receive a power voltage and performing wireless communications processing using a first frequency band;
a second front-end unit configured to receive the power voltage and performing wireless communications processing using a second frequency band higher than the first frequency band; and
a harmonic filter unit connected between a power voltage terminal and a power terminal of the first front-end unit receiving the power voltage to block harmonics within a central frequency of the first frequency band.

2. The dual band wireless communications apparatus of claim 1, wherein the harmonic filter unit includes at least one of a parallel resonance filter blocking secondary harmonics within the central frequency of the first frequency band and a series resonance filter allowing the secondary harmonics within the central frequency of the first frequency band to be bypassed to a ground.

3. The dual band wireless communications apparatus of claim 1, wherein the first frequency band is a wireless local area network (WLAN) frequency band of 2.4 GHz and the second frequency band is a WLAN frequency band of 5 GHz.

4. A dual band wireless communications apparatus, comprising:
a first front-end unit configured to receive a power voltage and performing wireless communications processing using a first frequency band;
a second front-end unit configured to receive the power voltage and performing wireless communications processing using a second frequency band higher than the first frequency band; and
a harmonic filter unit connected between a power voltage terminal and a power terminal of the second front-end unit receiving the power voltage to block harmonics within a central frequency of the first frequency band.

5. The dual band wireless communications apparatus of claim 4, wherein the harmonic filter unit includes at least one of a parallel resonance filter blocking secondary harmonics within the central frequency of the first frequency band and a series resonance filter allowing the secondary harmonics within the central frequency of the first frequency band to be bypassed to a ground.

6. The dual band wireless communications apparatus of claim 4, wherein the first frequency band is a wireless local area network (WLAN) frequency band of 2.4 GHz and the second frequency band is a WLAN frequency band of 5 GHz.

7. A dual band wireless communications apparatus, comprising:
a first front-end unit configured to receive a power voltage and performing wireless communications processing using a first frequency band;
a second front-end unit configured to receive the power voltage and performing wireless communications processing using a second frequency band higher than the first frequency band;
a diplexer disposed between each of the first front-end unit and the second front-end unit and an antenna terminal and allowing the first frequency band and the second frequency band to pass therethrough;
a harmonic filter unit connected between a power voltage terminal and a power terminal of the first front-end unit receiving the power voltage to block harmonics within a central frequency of the first frequency band; and
a band pass filter unit connected between the first front-end unit and the diplexer and allowing the first frequency band to pass therethrough.

8. The dual band wireless communications apparatus of claim 7, wherein the harmonic filter unit includes at least one of a parallel resonance filter blocking secondary harmonics within the central frequency of the first frequency band and a series resonance filter allowing the secondary harmonics within the central frequency of the first frequency band to be bypassed to a ground.

9. The dual band wireless communications apparatus of claim 7, wherein the band pass filter unit includes at least one of a high pass filter allowing the central frequency of the first frequency band to pass therethrough and a low pass filter allowing the central frequency of the first frequency band to pass therethrough.

10. The dual band wireless communications apparatus of claim 7, wherein the first frequency band is a wireless local area network (WLAN) frequency band of 2.4 GHz and the second frequency band is a WLAN frequency band of 5 GHz.

11. A dual band wireless communications apparatus, comprising:
a first front-end unit configured to receive a power voltage and performing wireless communications processing using a first frequency band;
a second front-end unit configured to receive the power voltage and performing wireless communications processing using a second frequency band higher than the first frequency band;
a diplexer disposed between each of the first front-end unit and the second front-end unit and an antenna terminal and allowing the first frequency band and the second frequency band to pass therethrough;
a first harmonic filter unit connected between a power voltage terminal and a power terminal of the first front-end unit receiving the power voltage to block harmonics within a central frequency of the first frequency band;
a second harmonic filter unit connected between the power voltage terminal and a power terminal of the second front-end unit receiving the power voltage to block the harmonics within the central frequency of the first frequency band; and
a band pass filter unit connected between the first front-end unit and the diplexer and allowing the first frequency band to pass therethrough.

12. The dual band wireless communications apparatus of claim 11, wherein each of the first and second harmonic filter units includes at least one of a parallel resonance filter blocking secondary harmonics within the central frequency of the first frequency band and a series resonance filter allowing the secondary harmonics within the central frequency of the first frequency band to be bypassed to a ground.

13. The dual band wireless communications apparatus of claim 11, wherein the band pass filter unit includes at least one of a high pass filter allowing the central frequency of the first frequency band to pass therethrough and a low pass filter allowing the central frequency of the first frequency band to pass therethrough.

14. The dual band wireless communications apparatus of claim 11, wherein the first frequency band is a wireless local area network (WLAN) frequency band of 2.4 GHz and the second frequency band is a WLAN frequency band of 5 GHz.

15. A dual band wireless communications apparatus, comprising:
a 2.4 GHz front-end unit configured to receive a power voltage and performing wireless communications processing using a 2.4 GHz frequency band;
a 5 GHz front-end unit configured to receive the power voltage and performing wireless communications processing using a 5 GHz frequency band;
a diplexer disposed between each of the 2.4 GHz front-end unit and the 5 GHz front-end unit and an antenna terminal and allowing the 2.4 GHz frequency band and the 5 GHz frequency band to pass therethrough;
a harmonic filter unit connected between a power voltage terminal and a power terminal of the 2.4 GHz front-end unit receiving the power voltage to block secondary harmonics within a central frequency of the 2.4 GHz frequency band; and
a band pass filter unit connected between the 2.4 GHz front-end unit and the diplexer and allowing the 2.4 GHz frequency band to pass therethrough.

16. The dual band wireless communications apparatus of claim 15, wherein the harmonic filter unit includes at least one of a parallel resonance filter blocking the secondary harmonics within the central frequency of the 2.4 GHz frequency band and a series resonance filter allowing the secondary harmonics within the central frequency of the 2.4 GHz frequency band to be bypassed to a ground.

17. The dual band wireless communications apparatus of claim 15, wherein the band pass filter unit includes at least one of a high pass filter allowing the central frequency of the 2.4 GHz frequency band to pass therethrough and a low pass filter allowing the central frequency of the 2.4 GHz frequency band to pass therethrough.
